(19) United States
(12) Patent Application Publication
(10) Pub. No.: US 2025/0171185 A1
(43) Pub. Date: May 29, 2025

(54) Method and apparatus for inspecting container closures placed on containers

(71) Applicant: KRONES AG, Neutraubling (DE)

(72) Inventor: Thomas BOCK, Hemau (DE)

(21) Appl. No.: 18/959,228

(22) Filed: Nov. 25, 2024

(30) Foreign Application Priority Data
Nov. 24, 2023 (DE) 10 2023 132 891.3

(51) Int. Cl. B65B 57/02; B65B 61/26; G06T 7/00; G06T 7/62

(52) U.S. Cl. CPC B65B 57/02; B65B 61/26; G06T 7/0004; G06T 7/62

(57) ABSTRACT

A closure apparatus has at least two closure units, which each attach container closures to containers. An inspection device arranged downstream from the closure apparatus in a transport direction for inspecting the containers provided with the closures has at least two image recording devices, which each record at least one spatially resolved image of each container and an evaluation device which evaluates the recorded images and determines at least one measured value from the images, wherein this measured value is characteristic of the container closures arranged on the containers.

### BACKGROUND OF THE INVENTION

The present invention relates to a method and an apparatus for inspecting container closures.

It has long been known from the prior art that in the context of manufacturing beverage containers, an inspection of their closures is also performed. Sometimes individual closed containers are removed from the container stream, and the container closures are inspected. It is also known to check the capper settings. It is accordingly known that before production, a capper cycle of closed bottles is discharged, and the diameter of the applied crown caps, for example, is measured manually using a gauge.

In the prior art, this must be performed by an employee before each production. This type of measurement is usually done off-line. This means that not all of production is monitored, and a capping error that occurs is not detected since the closure inspections usually do not work very accurately. In addition, the closure inspections known in the prior art currently work using a pattern comparison method and therefore do not assess the measured diameter, for example.

A method and an apparatus for detecting closures of containers are known from EP 3 605 010 A1. Closures are examined which have a cork-like element which engages in the mouth of the container.

GB 2 135 447 A describes a method for inspecting screw-on closures.

An inspection device for container closures is known from DE 10 2014 107 915 A1. Here, an optical lens is designed as a rotationally symmetrical lens and has at least two lens regions of which one lens region has a convex surface, and at least one further lens region has a plano-spherical surface.

WO 2019/003170 A1 describes a method and an apparatus for transferring piece goods to a transport line.

The present invention is based on the object of providing a method and an apparatus which in particular also make possible an in-line inspection of the closures and in particular of the screw-on and/or crown cap closures.

### SUMMARY OF THE INVENTION

In a method according to the invention for handling containers provided or to be provided with container closures, filled containers (filled with a flowable substance, in particular a liquid and in particular with a beverage) are transported, and a closure apparatus provides and in particular closes each of these containers with container closures, wherein these container closures are crown caps or screw-on closures, wherein the closure apparatus has at least two closure units which each attach the container closures to the containers, and wherein an inspection device arranged downstream from the closure apparatus in a transport direction inspects the containers provided with the closures.

According to the invention, the inspection device has at least two image recording devices, each of which records at least one spatially resolved image of at least some containers and preferably of each container and/or the container closure arranged on the container, and an evaluation device is also provided which evaluates the recorded images and determines at least one measured value from the images, wherein this measured value is characteristic of the container closures arranged on the containers.

More specifically, at least one measured value is determined which is characteristic of a physical property of the container closures arranged on the containers. This property is preferably a geometric dimension and in particular a diameter of the container closures arranged on the containers.

It is therefore proposed that container closures are inspected in-line and in particular during production mode. It is particularly preferred that each of the closed containers is inspected and/or checked. However, it would also be possible for only every nth container to be inspected, or for randomly selected containers or their container closures to be inspected.

Basically, with these closures, the problem can arise that they, for example crown caps, sit too loosely on the containers. In this case, it may happen that air, for example, gets into the containers, which affects the shelf life of the product in the containers.

Conversely, however, it may also be the case that the closures are arranged too tightly on the containers, and this then leads to damage to the mouth during the opening of the containers, for example by glass breaking at the container mouth. With screw-on caps, the problem can arise that they are screwed too tightly onto the mouth and can no longer be loosened by hand, or the container is damaged while being unscrewed.

In a preferred method, the containers are transported along a circular-segment-like transport path while being closed with the container closures.

Preferably, the closure apparatus has at least 3, preferably at least 4, closure units. These closure units can, for example, be designed as capper heads which attach the closures to the containers, for example presses them onto the containers. In addition, these closure units can also be designed as capper heads which screw or flange the container closures onto the containers.

Preferably, the closure apparatus has at most 80, preferably at most 60, preferably at most 50 and preferably at most 40 closure units.

Preferably, these closure units are arranged on a rotatable carrier. Particularly preferably, holding devices for holding the individual containers are also arranged on this rotatable carrier. Preferably, each of these holding devices is assigned exactly one closure unit.

Preferably, the respective closure units each have drive devices which bring about the attachment of the container closures to the containers. In a further preferred embodiment, the closure units can be controlled independently of one another. This means that preferably the individual closure units and in particular the movements carried out by these closure units are not coupled to each other.

Particularly preferably, the containers are transported at a transport sped that is greater than 0.5 m/s, and preferably greater than 1 m/s. In a further preferred method, the containers are transported at a speed which is less than 5 m/s, preferably less than 4 m/s, preferably less than 3 m/s, and preferably less than 2.5 m/s.

Preferably, the containers to be closed are transported with a first transport device, and the containers closed with the container closures are transported with a second transport device. Preferably, this second transport device is a conveyor belt.

Preferably, the containers are transported in a straight line during their inspection. It is particularly preferred that the containers are transported during their inspection by an in particular single-lane conveyor belt.

The containers are particularly preferably transported at a distance from one another. The containers are preferably transported individually. Preferably, a distance between the containers transported by at least one transport device during their inspection is less than twice the diameter of a container, preferably less than 1.5 times the diameter of a container, preferably less than 1.0 times the diameter of a container, and particularly preferably less than 0.5 times the diameter of a container.

In further preferred embodiments, the image recording device(s) is/are a camera or cameras. Particularly preferably, this image recording device or these image recording devices are aligned such that they observe the containers and/or the container closures obliquely or perpendicularly to a longitudinal direction of the containers.

Particularly preferably, a recording angle with respect to a direction perpendicular to the longitudinal direction and/or with respect to a horizontal plane is less than 20°, preferably less than 15° and particularly preferably less than 10°. It would be possible for the image recording devices to observe the container closures arranged on the containers obliquely from above, but it would also be possible for the image recording device(s) to observe the container closures arranged on the containers obliquely from below. Observation perpendicular to the longitudinal direction of the containers would also be possible.

The containers are preferably plastic bottles or glass bottles. The liquid within the containers is in particular a beverage such as beer, lemonade, juices or water.

In a further preferred method, the container closure is measured to determine said measured value. Particularly preferably, the container closure is measured in a three-dimensional space. This three-dimensional space can, for example, be created based on a detection of the position of the container. In this way, said measurement value can be determined which, as mentioned above, is in particular a diameter or a radius of the closure. However, it would also be possible to determine another value, in particular a value that allows conclusions about the diameter such as a curvature of a peripheral edge of the container closure.

Particularly preferably, an assignment device assigns the measured value to the closure unit which closed the container with the inspected container closure. If, as mentioned above, a plurality of closure units are provided, an inspected container is preferably thereby assigned to the closure unit which closed this container.

With the additional organ assignment to the closure units described here, complete monitoring of the closure apparatus and/or the closing organs or closure units and/or the production is possible-in particular in-line.

In a preferred method, a plurality of the above-mentioned measured values are recorded for a plurality of container closures and preferably saved. In this way, it is possible to identify trends such as a deterioration in closure quality. This deterioration can preferably also be determined for individual closure units.

For example, it can accordingly be determined for the nth closure unit that the closure quality has changed.

Preferably, said measured value is determined for a predetermined area of the container closure, for example for its peripheral edge that surrounds the mouth of the container.

In a further preferred method, at least two, preferably at least three and particularly preferably at least images recorded by the image recording devices are evaluated in order to determine the measured value, wherein the measured value is in particular a diameter. Preferably, these images are evaluated independently of each other.

In a further preferred method, the at least two and preferably at least three images recorded by the image recording devices are combined into a panoramic image and/or a development image of at least one section of the container closure. For example, a 360° development of a peripheral edge of the container closure arranged on the container can be shown.

In a further preferred method, a location and/or position of the container and/or the container closure is detected. In this way, a plane can be formed in which a surface of the closure lies. By determining a second plane which intersects the first plane, in particular at an angle of 90°, a specific value such as a diameter of the closure can then be determined by measuring the closure.

Preferably, the position is determined from the recorded image of the container closure. Preferably, the measured value is also determined from this image or with the aid of this image.

In a further preferred method, a geometric center of the container closure is determined. Particularly preferably, this geometric center is determined from the image(s) taken of the container closures.

Preferably, a diameter of the container closure is determined taking into account its center. Preferably, the above-mentioned plane which intersects the horizontal plane is selected such that it runs through the center of the container closure.

In a further preferred method, the measured value is a diameter of the closure arranged on a container, or a measured value that is characteristic of this diameter. Particularly preferably, the measured value is a diameter of the container closure determined at a predetermined height of the container closure.

Preferably, the diameter is determined with an accuracy that is less than 0.5 mm, preferably less than 0.4 mm, preferably less than 0.3 mm, preferably less than 0.2 mm, and particularly preferably less than 0.1 mm.

Particularly preferably, a diameter is determined at a location on the closure, and it is assumed that the diameter has a substantially circular cross-section. A circular cross-section is also understood to be cross-sections which have a wavy outer cross-section, as is in particular but not exclusively the case with crown caps.

However, it would also be conceivable to determine the diameter at two points on the container closure, for example using two lines that each pass through the determined center of the container closure and that intersect at an angle of 90°.

In a preferred embodiment, (at least) two image recording devices and in particular two cameras are provided. These two cameras are offset from each other by a predetermined angle (with respect to their viewing direction). This angle is preferably between 100° and 200°, preferably between 120° and 180°, preferably between 140° and 160° and particularly preferably about 150°.

This allows measurements using two points on the container closure, for example using two planes that each run through the center and intersect preferably at an angle of at least 20°, preferably at least 30°, preferably at least 50°, preferably at least 60°, preferably at least 70°, preferably at least 80° and particularly at least 90°.

In a further preferred method, a position of the closed container is detected, and the measured value is preferably determined taking this position into account. In this case, the position of the container in its transport direction is particularly preferably detected. Particularly preferably, however, the position of the container and/or of the container closure are detected in a direction perpendicular to the transport direction.

Particularly preferably, not only the position of the container or of the container closure but also the measured value are determined from the images recorded by the at least two and preferably the at least three image recording devices.

In a further preferred method, the measured value is determined taking this position into account.

It is possible for the position of the container and/or of the container closure to be first detected from a recorded image of the container, and for the value for the diameter, for example, to be determined on the basis of this detected position.

Preferably, on the basis of the detected position, the above-mentioned plane is positioned through the closure plane, in particular through an upper closing wall of the closure. Preferably, a center of the container closure is determined in this image or using this plane. In another step, a second plane which runs obliquely or perpendicular to said plane is positioned in such a way that it runs through a center of the closure. On the basis of this plane of intersection or more precisely of the resulting line of intersection, one or more edge points of the container closure are then preferably determined. By these edge points, the diameter can then be preferably determined.

In a further preferred method, measured values are saved and/or logged for a plurality of container closures. For example, the diameter of the closure can be saved and/or logged for a plurality of recorded closures. In this case, this measured value, in particular a diameter, can particularly preferably also be assigned to the corresponding closure units.

In a further preferred method, inspected containers are discharged, in particular depending on an inspection result or a measured value. For example, containers can be discharged if it turns out that the diameter of the container closure is outside a tolerance window so that the container is not properly closed.

Preferably, the determined measured values are compared with reference values. For example, measured diameters of container closures can thus be compared with (saved) reference values.

Particularly preferably, the method described here is carried out at least at the start of production or after a product change. For example, the performed measurement results can thus be logged, for example in the manner of a laboratory quality log.

Particularly preferably, the entire production is monitored (in particular continuously). However, it would also be possible for production to be monitored on a random basis.

In a further preferred method, the measurements or inspections are logged and/or saved with a time stamp. In this way, it is possible to trace at a later time when and on which containers or container closures the respective measurements were carried out.

Particularly preferably, at least one measured value and measurement results in general are attached to the container (for example printed thereon), or preferably at least one marking is attached to a container which is characteristic of at least one measurement result and/or at least one measured value. Furthermore, it is possible to store containers inspected and marked in this way as reference samples and/or to discharge them (e.g. onto a laboratory belt or the like).

In a further preferred method, the closure apparatus and/or at least one closure unit is controlled and preferably regulated in response to a measured value and/or taking this measured value into account. Accordingly for example, a closed-loop function can be set up for the closure apparatus or the individual closure units. It would also be possible for production to be halted or stopped if quality guidelines are not met.

In a further preferred method, the measured value is determined at a region of the container closure that surrounds the container mouth. Preferably, the container closure has a section or region that covers a container opening and a second region that surrounds the container mouth. It is particularly preferred to carry out the measurement (to determine the measured value) in this second region.

In the case of a crown cap, the measured value is particularly preferably determined at a lower edge of the respective teeth. However, it would also be possible to determine the diameter at valleys between the teeth or a diameter above the teeth. Measuring in this lower region has the advantage that, for example, during an inspection from above, if the measurement is not taken exactly in the middle below the camera, the teeth will be shaded, and the correct diameter cannot be measured or can only be measured with difficulty.

Preferably, the radius or diameter at the lower edge of the teeth of the closure is the decisive position for the question as to whether the container is closed correctly, i.e. not too loosely and not too tightly.

Particularly preferably, the dimension of the teeth valleys and/or teeth is determined as well as their distance from each other. Preferably, the distances between the teeth are determined at the lower edge of the teeth.

In a further preferred method, the apparatus has at least three, preferably at least four, image recording devices, and/or the container closure is inspected using at least three and preferably at least four image recording devices.

Particularly preferably, the at least two, preferably the at least three image recording devices are calibrated to one another. In particular, the at least two and in particular the at least three image recording devices are calibrated with regard to their position and/or their orientation. For this purpose, for example, a calibration body can be provided which is arranged in the center between the image recording devices. The calibration can then be carried out in such a way that the images from the image recording devices each capture the calibration body in the same way (but from different directions).

In a further preferred method, the position of the container is determined in a global coordinate system (or a higher-level and in particular stationary coordinate system). This is particularly preferably done using image recording devices calibrated to one another. In this case, taking a panoramic image is not absolutely necessary.

If the position of the container in a global coordinate system is known, the coordinates of the bottom edges of the teeth can also be determined in this global coordinate system. From this, the diameter of the container closure can be determined.

In a further preferred method, the container closure has a covering region and/or a covering plane which covers an opening of the container as well as a circumferential edge which surrounds the mouth of the container (preferably completely), and said measured value is determined with respect to this circumferential edge. The size of the covering plane is not influenced by the closing process, but the diameter of the circumferential edge can be a clear indication of the quality of the closure of the container.

In a further preferred method, the container closures are illuminated and are illuminated in particular by means of at least one and preferably exactly one lighting device which is preferably arranged above the containers. It is therefore particularly preferred to inspect the container closures using a reflected light method. Preferably, the lighting device is a lighting device which emits diffuse light. Preferably, the illumination of the container closure is triggered by an image taken by the inspection device.

Preferably, the images are taken using the at least two and preferably the at least three image recording devices simultaneously.

Particularly preferably, an approximate position of the containers is determined and then an inspection and/or image recording is initiated by this approximate position determination. For example, a light barrier can accordingly be provided which triggers and/or initiates the image recording or inspection.

The present invention is further directed to a method for inspecting containers provided with container closures, wherein the container closures are crown caps or screw-on closures, and wherein a transport device transports the containers provided with the container closures in a transport direction, and an inspection device inspects the containers provided with the container closures.

According to the invention, the inspection device has at least two image recording devices and preferably at least three image recording devices, each of which records at least one spatially resolved image of at least some of the containers and preferably of each container, wherein an evaluation device evaluates the recorded images and derives and/or determines at least one measured value from the images, wherein this measured value is characteristic of the container closures arranged on the containers and is in particular characteristic of at least one physical property and in particular one geometric property of these container closures such as in particular a diameter of the container closures.

Preferably, the above-described method steps are carried out.

The present invention is further directed to an apparatus for handling containers provided with container closures, with a transport device which is suitable and intended for transporting containers filled with a medium and in particular a liquid, and with a closure apparatus which is suitable and intended for providing each of these containers with container closures, wherein these container closures are crown caps or screw-on closures. The closure apparatus has at least two closure units, each of which is suitable and intended to attach the container closures to the containers, and an inspection device arranged downstream from the closure apparatus in the transport direction is also provided which is suitable and intended to inspect the containers provided with the closures. Preferably, this inspection device is suitable and intended to inspect the containers provided with the container closures and/or these container closures during their movement.

According to the invention, the inspection device has at least two and preferably at least three image recording devices which are suitable and intended to record at least one spatially resolved image of several and preferably of each container, and an evaluation device is provided which is suitable and intended to evaluate the recorded images and to determine at least one measured value from the images, wherein this measured value is characteristic of the container closures arranged on the containers.

Preferably, the apparatus described here is suitable and intended to carry out the method described above.

Particularly preferably, the apparatus has an assignment device which is suitable and intended to assign the closure unit which has closed the container with the inspected container closure and/or which has arranged this container closure on the container to the measured value(s) and/or an image of a container closure recorded by at least one image recording device.

In a further preferred embodiment, the apparatus has a position determination device which is suitable and intended to detect a position of the closed container or of the container provided with the container closure.

Preferably, the position is determined by the two and preferably at least three image recording devices. In an alternative embodiment, the position is determined by a camera mounted concentrically above the container closure.

Particularly preferably, the evaluation device is suitable and intended to determine said measured value taking into account the detected position.

In a further preferred embodiment, the apparatus has a lighting device which is suitable and intended for illuminating the container closed with the container closure, and in particular also for illuminating the container closure.

The present invention is furthermore directed to an apparatus for inspecting containers provided with container closures, wherein the container closures are crown caps or screw-on caps. This apparatus has a transport device which is suitable and intended to transport the containers provided with the closures in a transport direction, as well as an inspection device which is suitable and intended to inspect containers provided with the container closures and in particular the container closures.

Particularly preferably, the inspection device has at least two and preferably at least three image recording devices which is or are suitable and intended to record at least one spatially resolved image of several and preferably of each container (provided with a container closure). Furthermore, an evaluation device is provided which is suitable and intended to evaluate the recorded images and to determine and/or ascertain at least one measured value from the images, wherein this measured value is characteristic of the container closures arranged on the containers.

Particularly preferably, the two or at the least three image recording devices are synchronized with each other such that they each record images at the same time.

Particularly preferably, the at least two and preferably the at least three image recording devices observe the container provided with the container closure from two different directions.

In a further advantageous embodiment, the apparatus has a marking device for marking the inspected containers, wherein this marking device is preferably suitable and intended to apply a marking to the containers which makes possible a conclusion about the measured value determined with respect to this container.

In a further preferred embodiment, the apparatus has at least one background element which can be observed by at least one image recording device. Particularly preferably, each image recording device is assigned a background element which can be optically detected by this image recording device.

Preferably, such a background element is arranged on at least one image recording device and preferably on each image recording device and can be detected by an opposite image recording device and is thereby assigned to this image recording device.

Preferably, the respective background elements are arranged such that the container to be inspected is arranged between the image recording device and the background element assigned to this image recording device.

This background element is preferably designed homogeneously. Preferably, the background element is at least partially white in color and preferably homogeneously white in color.

### BRIEF DESCRIPTION OF THE DRAWINGS

Further advantages and embodiments emerge from the accompanying drawings, in which:

FIG. 1 shows a schematic representation of an apparatus according to the invention;

FIG. 2 shows a representation of image recording with three image recording devices;

FIG. 3 shows a side view of image recording with three image recording devices;

FIG. 4 shows images of recorded container closures;

FIG. 5 shows images of recorded container closures;

FIG. 6 shows a representation of image recording with four image recording devices;

FIG. 7 shows a side view of image recording with four image recording devices;

FIG. 8 shows a representation of an inspection device; and

FIG. 9 shows a block diagram representation of a method according to the invention.

### DETAILED DESCRIPTION OF THE INVENTION

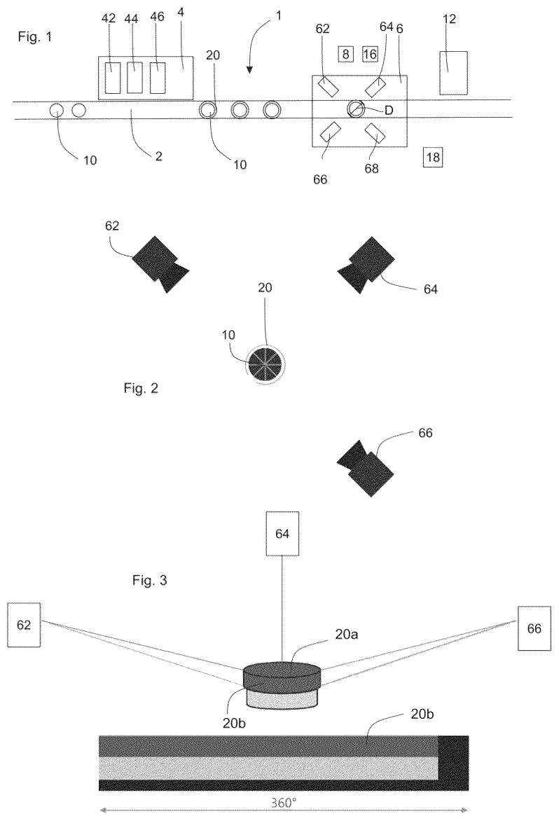

FIG. 1 shows a schematic representation of an apparatus 1 according to the invention. This comprises a transport device 2 which transports containers 10. Although not shown, this transport device 2 is preferably composed of a plurality of transport units, which preferably connect to one another. Contrary to what is shown, the containers are preferably not transported continuously in a straight line but preferably at least partially on a circular-segment-shaped transport path.

These containers are, as shown in FIG. 1 on the left-hand side, initially still unclosed but already filled.

The reference sign 4 designates a closure apparatus. This has several closure units 42, 44, 46 which each provide the individual containers with container closures 20 as shown on the right-hand side next to the closure apparatus 4.

The containers 10 provided with the container closures are transported to an inspection device 6 which here has four image recording devices 62, 64, 66, 68, which preferably simultaneously record images of the container closures 20 arranged on the containers.

The reference sign 8 designates an assignment device which assigns to each container, and/or each recorded image of a container and/or of a container closure, the closure unit 42, 44, 46 which closed this container.

The reference sign 16 schematically indicates an evaluation device which serves to evaluate the images recorded by the image recording devices. It is possible for this evaluation device to combine the recorded images into a panoramic image.

Preferably, the evaluation device also determines an exact position of the container closure (within the image). Furthermore, the evaluation device 16 preferably determines a value which is characteristic for the container closure and in particular its diameter D.

The reference sign 18 designates a memory device in which determined measurement values are saved, in particular with an assignment to the individual closure units 42, 44, 46 and/or with time information.

The reference sign 12 designates a discharge device which is suitable and intended to discharge individual containers from the transport path. Preferably, this discharge is in response to a measured value determined by the inspection device.

FIG. 2 shows an inspection which is carried out here with three image recording devices 62, 64, 66.

One of the three image recording devices, here the image recording device 64, makes possible the exact determination of the position of the container 10.

Preferably, a plane (of image recording) is adjusted to the crown cap, whereby oblique necks can be compensated. This means that it can be preferentially taken into account that the planes of the container closures do not exactly lie in a horizontal plane.

By measuring the exact position of the container, it is possible to measure the diameter of the container closure such as a crown cap. In one embodiment, the container closures must have a diameter between 28.58 mm and 28.75 mm if they are correctly applied.

It is possible to expand filler and/or closure apparatus management based on the measured values determined in this way. In particular, the individual closure units of the closure apparatus can be controlled and/or regulated taking the measured values into account.

As mentioned above, there is preferably an assignment of the crown cap diameter to an organ, i.e. the individual measured diameters are preferably assigned to those closure units which have attached the relevant container closure to the container.

FIG. 3 schematically shows image recording of a container closure 20 by means of three image recording devices. The container closure 20 has a cover section 20a and a circumferential section 20b.

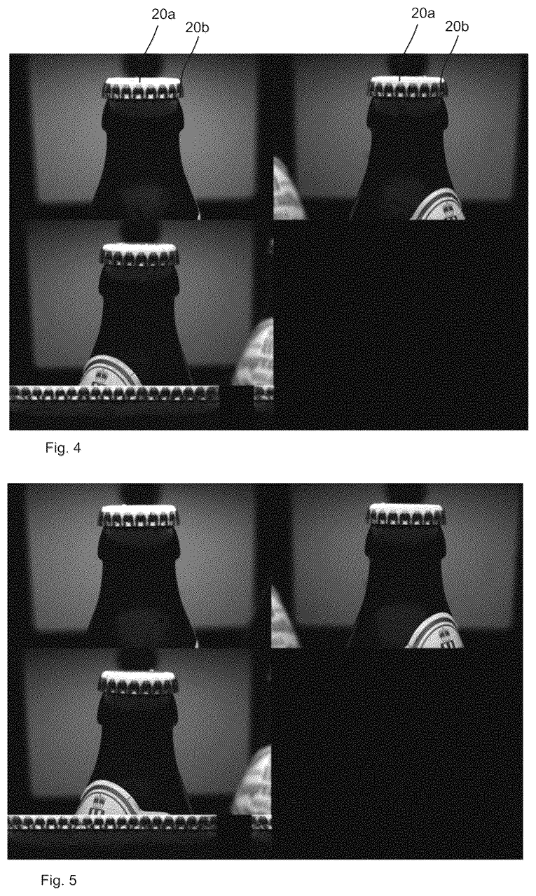

FIGS. 4 and 5 each show recorded images of container closures arranged on containers. In each case, the cover section 20a of the container closure 20 can be seen, which covers the opening of the container 20 as well as the circumferential edge 20b, which surrounds the mouth of the container. Preferably, the diameter is determined in the region of the circumferential edge and in particular in the region of the ends 20c of the individual teeth of the crown cap. This serrated region of the crown cap is also visible in the development 22.

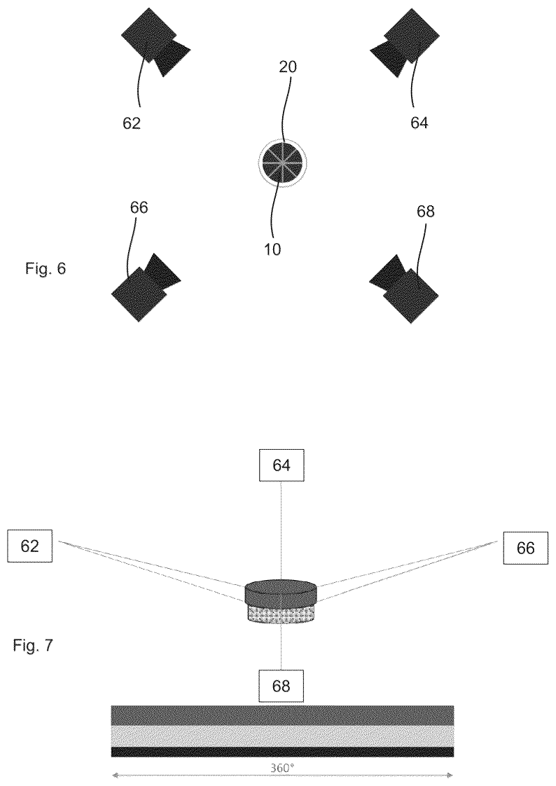

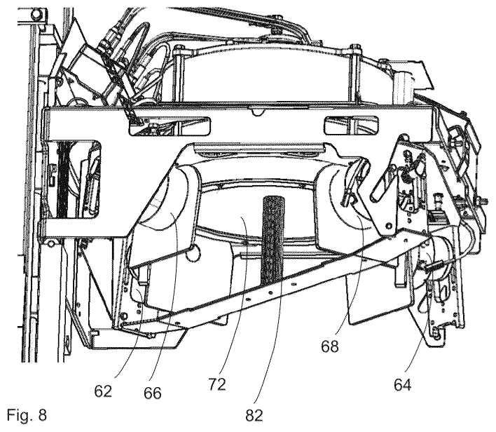

FIG. 6 shows an embodiment in which the inspection is carried out with four image recording devices 62, 64, 66, 68. Using 4 image recording devices, it is possible to cover an area of four times 90°. The result is a development with no dead space. As shown in FIG. 7, in this case the four image recording devices are 62, 64, 66, 68 are evenly arranged around the container closure 20 and observe it obliquely from above.

The most precise positioning is possible when using 4 image recording devices. In addition, an adaptation of a plane to the container closure and in particular to a crown cap is the most robust. This results in a very precise determination of the diameter of the container closure and in particular the crown cap diameter.

FIG. 8 shows an inspection apparatus 6. The individual image recording devices 62, 64, 66, 68 are shown here.

The reference sign 72 designates a lighting device which is preferably arranged symmetrically with respect to a geometric center between the image recording devices. Furthermore, this lighting device is arranged above the containers to be inspected (not shown).

The reference sign 82 designates a calibration body which serves for the calibration of the individual image recording devices (in particular with respect to one another). During operation, the calibration body is removed.

Preferably, background elements or background disks 92, 94, 96, 98 are arranged on the individual image recording devices 62, 64, 66, 68. These background elements each serve to improve the image recording by the respective opposite image recording device.

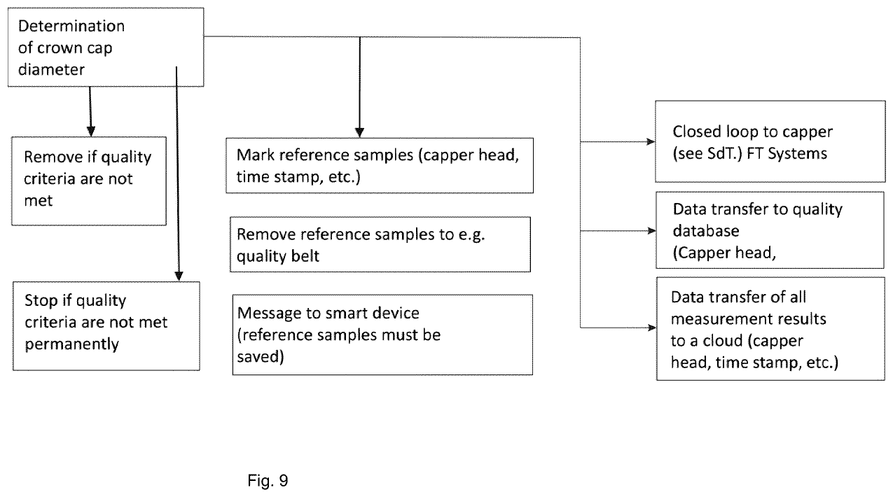

FIG. 9 shows a representation to illustrate container handling. First, the diameter of the container closure, in this case a crown cap, is determined. The determined diameter is preferably compared with a target value. If the determined diameter deviates from the target value and in particular lies outside a tolerance window formed around the target value, the relevant container in question is discharged.

If it is determined that, for example, the target values for the diameter of the container closures are not met for a plurality of containers or, for example, for all containers that were closed by a specific closure unit, a machine stop can be initiated. However, it would also be possible to deactivate the closure unit in question in such a way that no containers are closed by this closure unit until the next maintenance break.

In addition, the inspected container can be marked with the measured diameter. The closure unit which closed this container can also be identified in this marking. In addition, a time stamp can also be applied with the marking.

Preferably, a container marked in this way is discharged, for example so that it is available as a reference sample. This discharge can be onto a quality belt, for example.

Preferably, this discharge can be reported to a control device (smart device) so that the reference samples can be saved.

Furthermore, the closure apparatus can also be controlled using the determined diameter and, in particular, the individual closure units of the closure apparatus can be controlled and, in particular, regulated. If, for example, it is determined that the diameters of the container closures that were arranged on the containers by a specific closure unit always deviate from a target diameter by a certain amount, this specific closure unit can be adjusted.

Furthermore, it is also possible for the measured diameters to be forwarded to a database, in particular a quality database. In this way, long-term monitoring of quality conditions is also possible.

Furthermore, all measured data, i.e. all inspection results, can be forwarded to a database. In this way, continuous monitoring of all closure units can be carried out. In this way, quality control can also be carried out across machines.

The measured values can be saved to a cloud (preferably also with a time stamp).

The applicant reserves the right to claim all features disclosed in the application documents as essential to the invention, provided that they are novel over the prior art individually or in combination. It is also pointed out that features which can be advantageous in themselves are also described in the individual figures. A person skilled in the art will immediately recognize that a particular feature described in a figure can be advantageous even without the adoption of further features from this figure. Furthermore, the person skilled in the art will recognize that advantages can also result from a combination of several features shown in individual or in different figures.

1. A method for handling containers provided with or to be provided with container closures, wherein filled containers are transported, and a closure apparatus provides each of these containers with container closures, wherein these container closures are crown caps or screw-on closures, and wherein the closure apparatus has at least two closure units which each attach the container closures to the containers, and wherein an inspection device arranged downstream from the closure apparatus in the transport direction inspects the containers provided with the closures, wherein the inspection device has at least two image recording devices which each record at least one spatially resolved image of each container, and an evaluation device evaluates the recorded images and determines at least one measured value from the images, wherein this measured value is characteristic of the container closures arranged on the containers.

2. The method according to claim 1, wherein an assignment device assigns the measured value to the closure unit which closed the container with the inspected container closure.

3. The method according to claim 1, wherein the at least two images recorded by the image recording devices are evaluated in order to determine the measured value.

4. The method according to claim 1, wherein the measured value is characteristic of a diameter of the container closure arranged on the container and is determined with an accuracy of less than 0.5 mm.

5. The method according to claim 1, wherein a position of the closed container is detected.

6. The method according to claim 1, wherein the container closure has a cover plane which covers an opening of the container and a circumferential edge which surrounds the mouth of the container, and the measured value is determined with respect to this circumferential edge.

7. The method according to claim 1, wherein the container closures are illuminated.

8. The method according to claim 1, wherein the closure apparatus and/or at least one closure unit is controlled taking into account the measured value.

9. A method for inspecting containers provided with container closures, wherein these container closures are crown caps or screw-on closures, wherein a transport device transports the containers provided with the closures in a transport direction, and an inspection device inspects the containers provided with the container closures, wherein the inspection device has at least two image recording devices which each record at least one spatially resolved image of each container, and an evaluation device evaluates the recorded images and determines at least one measured value from the images, wherein this measured value is characteristic of the container closures arranged on the containers.

10. An apparatus for handling containers provided or to be provided with container closures, with a transport device which is configured for transporting containers filled with a medium, and with a closure apparatus which is configured for providing each of these containers with container closures, wherein these container closures are crown caps or screw-on closures, and wherein the closure apparatus has at least two closure units which are each configured for attaching the container closures to the containers, and wherein an inspection device is provided which is arranged downstream from the closure apparatus in a transport direction and is configured for inspecting the containers provided with the closures, wherein the inspection device has at least two image recording devices which are suitable and intended for recording at least one spatially resolved image of several containers and an evaluation device which is configured for evaluating the recorded images and determining at least one measured value from the images, wherein this measured value is characteristic of the container closures arranged on the containers.

11. The apparatus according to claim 10, wherein the apparatus has an assignment device which is configured to assign a measured value and/or an image of a container closure recorded by at least one image recording device to the closure unit which arranged this container closure on the container.

12. The apparatus according to claim 10, wherein the apparatus has a position determination device which is configured to detect a position of the containers provided with the container closures.

13. An apparatus for inspecting containers provided with container closures, wherein these container closures are crown caps or screw-on closures, with a transport device which is configured to transport the containers provided with the container closures in a transport direction and an inspection device which is configured to inspect containers provided with the container closures, wherein the inspection device has at least two image recording devices which are configured to record at least one spatially resolved image of each container and/or the container closure arranged on the container, and an evaluation device is provided which is configured to evaluate the recorded images and to determine at least one measured value from the images, wherein this measured value is characteristic of the container closures arranged on the containers.

14. The apparatus according to claim 13, wherein the inspection device has at least three image recording devices.

15. The apparatus according to claim 13, wherein the apparatus has a marking device configured for marking the inspected containers.
